(19) United States
(12) Patent Application Publication
(10) Pub. No.: US 2004/0172570 A1
(43) Pub. Date: Sep. 2, 2004

(54) Generator of word clock synchronized with timing reference bit sequence inherent in serial digital signal

(76) Inventor: Takayuki Miyajiri, Kanagawa (JP)

Correspondence Address: FISH & RICHARDSON P.C., 1425 K STREET, N.W., 11TH FLOOR, WASHINGTON, DC, 20005-3500, US

(21) Appl. No.: 10/778,549

(22) Filed: Feb. 17, 2004

(30) Foreign Application Priority Data
Feb. 27, 2003 (JP) 50646/2003

(51) Int. Cl. G06F 1/12

(52) U.S. Cl. 713/400

(57) ABSTRACT

A word clock generator creates a serial clock signal having a frequency corresponding to the bit rate of a serial digital signal in which the number of bits in one word set as one data unit is “N”; creates a first word clock signal having a frequency corresponding to the word rate by dividing the frequency of the serial clock signal by N; creates a group of N word clock signals in a multiplicity of phases by delaying the phase of the first word clock signal by one period of the serial clock signal at a time and by giving said delay (N-1) times; converts the serial digital signal into parallel signals on the basis of the serial clock signal; determines whether or not a predetermined timing reference bit sequence exists in the parallel signals and detects phase information according to the timing reference bit; and selects the word clock signal having a phase coinciding with the phase information from the group of word clock signals in a multiplicity of phases and outputs the selected word clock signal.

### BACKGROUND OF THE INVENTION

The present invention relates to a word clock generator of a word clock synchronized with a predetermined bit pattern inherent in serial digital data.

Phase differences between a plurality of groups of serial digital data can be grasped and controlled by using a word clock signal in which phase information corresponding to a predetermined bit pattern (timing reference bit sequence) is reflected.

FIG. 1 shows the flow of an HD-SDI (high definition-serial digital interface) signal relating to one of possible fields of application of the present invention. If a plurality of video output devices (a video tape recorder (VTR) 12, a color bar generator 13 and a camera 14) exist in a broadcasting station, as shown in FIG. 1, one of HD-SDI signals needs to be selected as a broadcasting video signal from the video output devices by using a selector 15.

Each of the plurality of video output devices 12, 13, and 14 is supplied with a reference signal (ordinarily a black burst (BB) signal) from a reference signal generator 11, generates a serial clock (SCLK) synchronized with the reference signal, and outputs the HD-SDI signal timed by means of the serial clock. Selection between the HD-SDI video signals thus output cannot be performed by using the selector 15 with the signals as they are. One of the reasons for this is that video output devices 12, 13, and 14 ordinarily have different video output timings with respect to the reference signal. Another of the reasons is that the cables connected between the reference signal generator 11 and the plurality of video output devices 12, 13, and 14 ordinarily differ from each other in length so that phase differences occur between the plurality of HD-SDI signals. In other words, when switching between the plurality of HD-SDI signals having phase differences is performed, each HD-SDI signal can be output from the selector 15 as a signal having noise because the timings of the HD-SDI signals are different from each other.

A process described below is therefore performed as shown in FIG. 1. Information on the phases of the HD-SDI signals output from the plurality of video output devices 12, 13, and 14 or information on the phases between the HD-SDI signals output from the video output devices and the reference signal output from the reference signal generator 11 (e.g., the phase between the HD-SDI signal output from the camera 14 and the phase of the reference signal) is obtained through a waveform monitor 16. Thereafter, a sync circuit (not shown) incorporated in each video output device is operated and set by using the phase information to reduce the phase difference between the plurality of HD-SDI signals to zero. If the phase differences between the plurality of HD-SDI signals output from the plurality of video output devices 12, 13, and 14 are reduced to zero in this manner, each HD-SDI signal can be output from the selector 15 without noise when switching between the HD-SDI signals is performed.

As described above, it is important to grasp information on the phases of HD-SDI video signals output from video output devices in order to ensure the desired quality of broadcasting video signals. More specifically, the phase of a word clock synchronized with a timing reference bit sequence inherent in the HD-SDI video signal corresponds to the information on the phase of the HD-SDI video signal. Such a word clock generator is incorporated in, for example, an HD-SDI receiver module “HK-102” (FIG. 2) put on the market by Sony Corporation and a serial digital decoder LSI “GS9000” (FIG. 3) for SD-SDI (standard definition-serial digital interface) signal put on the market by Gennum Corporation.

The HD-SDI signal and the SD-SDI signal differ from each other in terms of serial data bit rate and number of bits in one word and have different timing reference bit sequences, but have common characteristics in that they are serial digital video signals and have inherent timing reference bit sequences. Therefore, the principle of the present invention described below can be applied to serial digital signals including the HD-SDI and SD-SDI signals.

In the technical field relating to the HD-SDI and SD-SDI signals, a parallel clock (PCLK) is ordinarily used instead of the word clock.

FIGS. 2 and 3 are block diagrams showing apparatuses respectively incorporating the word clock generator of Sony Corporation and the word clock generator of Gennum Corporation. Arrows 20 and 30 in the block diagrams indicate the word clock (parallel clock) generators. FIGS. 2 and 3 are disclosed in non-patent document 1 and non-patent document 2 referred to below but details of the operation of each generator are not disclosed.

The word clock (parallel clock) generator indicated by arrow 20 in FIG. 2 is thought to operate as described below. A frequency divider 21 divides a serial clock signal for an HD-SDI video signal to generate a word clock (parallel clock) signal, and a delay circuit 22 delays the word clock signal so that the word clock signal is synchronized with the timing reference bit sequence inherent in the HD-SDI video signal.

The word clock (parallel clock) generator indicated by arrow 30 in FIG. 3 is thought to operate as described below. A frequency divider circuit generates a word clock (parallel clock) signal in such a manner that when it divides a serial clock for an SD-SDI video signal, it resets its internal counter so that the word clock (parallel clock) signal is synchronized with the timing reference bit sequence inherent in the SD-SDI video signal.

(Non-Patent Document 1)

Hugo Gaggioni, Mamoru Ueda, Fumiaki Saga, Kazuo Tomita, and Nobuyoshi Kobayashi, “Serial Digital Interface for HDTV”, SMPTE Journal, Society of Motion Picture and Television Engineers, May 1997, pp. 298-304 (pp. 303 and 304, FIG. 5).

(Non-Patent Document 2)

S. Webster, E. Fankhauser, K. Chen, J. Francis, E. Isoszef, T. Rosati, I. Ridpath, and P. Moore, “A New Chip Set for Proposed SMPTE Standard SMPTE259M-Serial Digital Interface”, SMPTE Journal, Society of Motion Picture and Television Engineers, September 1993, pp. 777-785 (p. 783, FIG. 11).

The delay circuit 22 in the circuit shown in FIG. 2, however, delays the word clock signal independently of the timing reference bit sequence inherent in the HD-SDI video signal but dependently on its characteristics (e.g., the gate delay time and the CR time constant). Therefore, if the gate delay time or the CR values change under the influence of heat for example, the delay time of the delay circuit is changed. In such a case, the delay circuit 22 shown in FIG. 2 cannot delay the word clock by setting the delay time with stability. In other words, the word clock generator 20 shown in FIG. 2 cannot generate the word clock signal with stability.

The frequency divider circuit in the word clock generator 30 shown in FIG. 3 resets its internal counter dependently on the timing reference signal inherent in the SD-SDI video signal. Therefore the word clock generator 30 shown in FIG. 3 is capable of generating a word clock signal with stability. However, the frequency divider circuit is complicated and does not operate at a high speed. That is, since the counter of the frequency divider circuit is reset in correspondence with the timing reference bit sequence, there is a need to generate a reset timing signal by comparing phase information obtained from the timing reference bit sequence and the count value of the counter with each other. A comparison circuit for realizing this comparison is ordinarily constituted by a plurality of gate circuit stages. Therefore, the entire frequency divider circuit including the comparison circuit is complicated and incapable of operating at a high speed in comparison with frequency divider circuits which only perform frequency division by N. A high level of IC processing technology may be used to enable a complicated frequency divider circuit to operate at a high speed. However, the price of the frequency divider circuit is considerably increased in such a case.

### SUMMARY OF THE INVENTION

An object of the present invention is to provide a word clock generator capable of generating a word clock signal with stability.

Another object of the present invention is to provide a low-priced word clock generator capable of operating at a high speed.

To achieve the above-described objects, according to the present invention, there is provided a word clock generator having: means for outputting a serial clock signal having a frequency corresponding to the bit rate of a serial digital signal which is externally supplied to the means and in which the number of bits in one word set as one data unit is “N”; means for outputting a first word clock signal having a frequency corresponding to the word rate by dividing the frequency of the serial clock signal by N; means for outputting a group of N word clock signals in a multiplicity of phases by delaying the phase of the first word clock signal by one period of the serial clock signal at a time and by giving this delay (N-1) times; means for converting the serial digital signal into parallel signals on the basis of the serial clock signal and outputting the parallel signal with the same period as the first word clock signal, the conversion means being supplied with the serial digital signal, the serial clock signal and the first word clock signal; means for determining whether or not a predetermined timing reference bit sequence exists in the parallel signals, and for detecting phase information according to the timing reference bit sequence if the timing reference bit sequence exists; and means for selecting the word clock signal having a phase coinciding with the phase information from the group of word clock signals in a multiplicity of phases, and for outputting the selected word clock signal, the selection means being supplied with the phase information and the group of word clock signals in a multiplicity of phases.

### BRIEF DESCRIPTION OF THE DRAWINGS

FIG. 1 is a diagram showing the flow of an HD-SDI video signal;

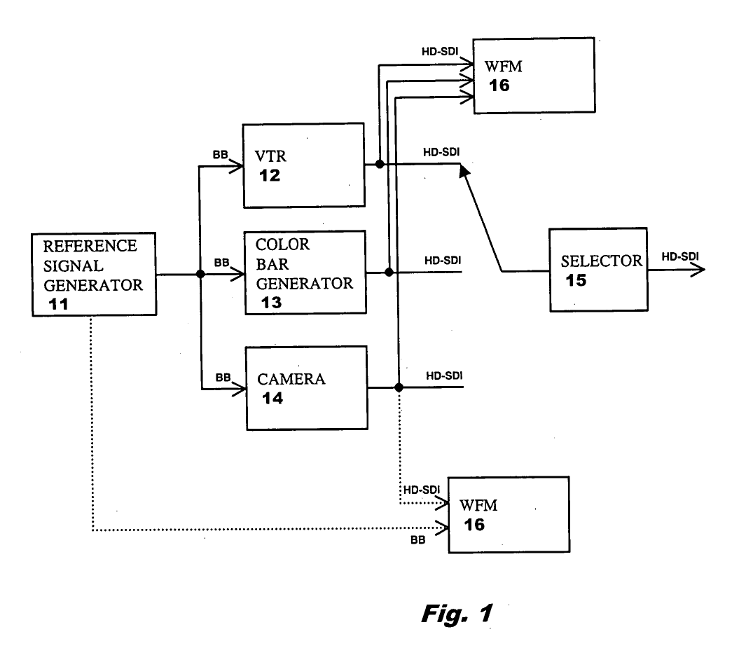

FIG. 2 is a block diagram of an apparatus in which a conventional word clock generator is incorporated;

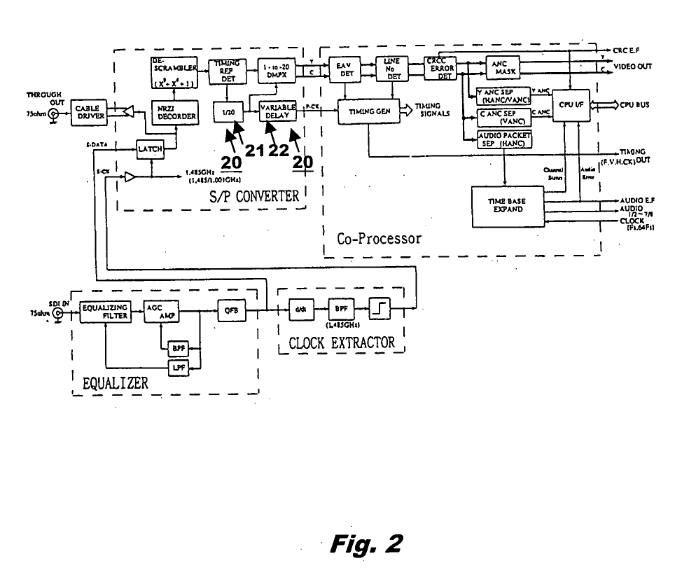

FIG. 3 is a block diagram of an apparatus in which a conventional word clock generator is incorporated;

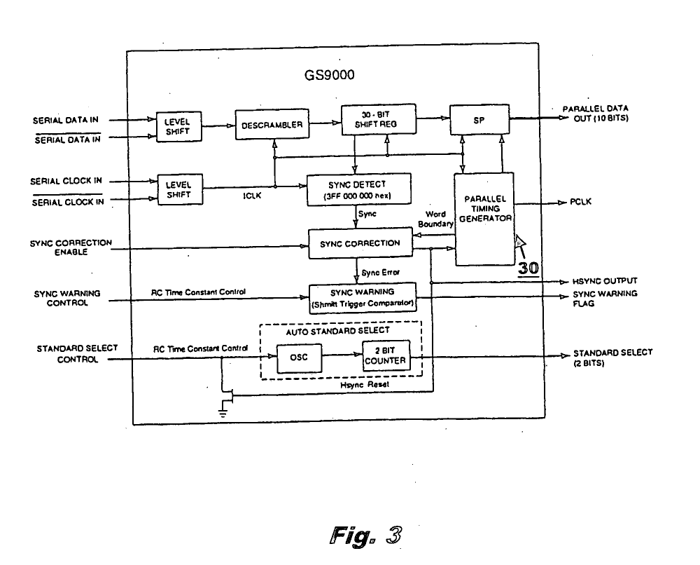

FIG. 4 is a block diagram of a word clock generator of the present invention;

FIG. 5 is a diagram showing an HD-SDI video signal input to a PLL shown in FIG. 4, and a serial clock signal output from the PLL;

FIG. 6 is a diagram showing a serial clock signal and a word clock signal input to a shift register shown in FIG. 4, and a group of word clock signals output in a multiplicity of phases from the shift register;

FIG. 7A is a block diagram showing details of an S/P conversion unit shown in FIG. 4;

FIG. 7B is a diagram showing the correspondence relationship between part of the HD-SDI video signal input to the S/P conversion unit shown in FIG. 7A and part of parallel video signals output from the S/P conversion unit;

FIG. 8A is a diagram showing part of a group of parallel video signals input to a bit pattern detection unit shown in FIG. 4 and part of a first group of reference signals output from the bit pattern detection unit;

FIG. 8B is a diagram showing part of the group of parallel video signals input to the bit pattern detection unit shown in FIG. 4 and part of a second group of reference signals output from the bit pattern detection unit;

FIG. 9 is diagram showing part of first and second groups of reference signals input to a bit phase detection unit shown in FIG. 4 and part of a group of determination signals generated by the bit phase detection unit;

FIG. 10A is a block diagram showing an example of modification of the S/P conversion unit shown in FIG. 7A;

FIG. 10B is a diagram similar to FIG. 7B and showing the correspondence relationship between an HD-SDI video signal and parallel video signals;

FIG. 11A is a diagram showing parallel video signals input to the bit pattern detection unit shown in FIG. 4 and a first group of reference signals output from the bit pattern detection unit, the signals corresponding to the example of modification of the S/P conversion unit shown in FIG. 10A;

FIG. 11B is a diagram showing the parallel video signals input to the bit pattern detection unit and a second group of reference signals output from the bit pattern detection unit; and

FIG. 12 is a diagram showing the first and second groups of reference signals input to the bit phase detection unit shown in FIG. 4 and corresponding to the bit pattern detection unit operating as shown in FIGS. 11A and 11B, and phase information output from the bit phase detection unit.

### DETAILED DESCRIPTION OF THE PREFERRED EMBODIMENTS

Embodiments of the present invention will be described with reference to the accompanying drawings.

### First Embodiment

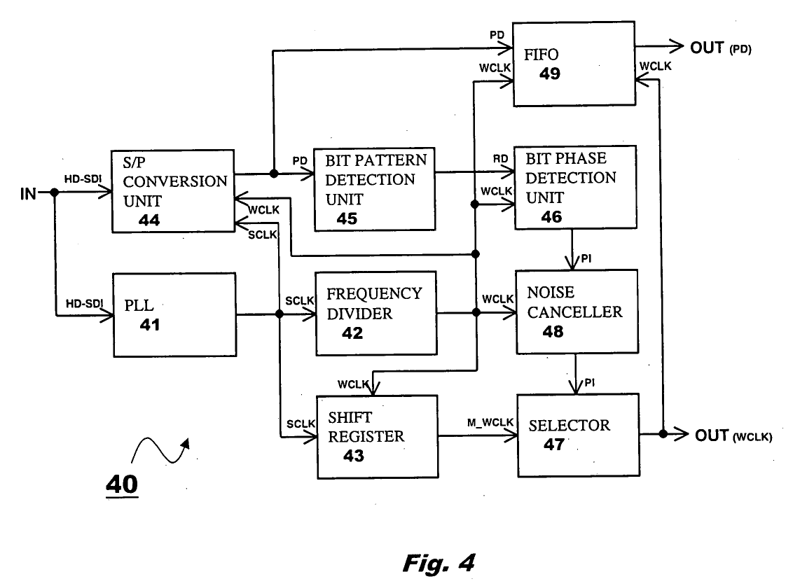

FIG. 4 is a block diagram of a word clock (parallel clock) generator 40 in accordance with the present invention. As shown in FIG. 4, the word clock generator 40 has: a phase-locked loop (PLL) 41 to which an HD-SDI video signal is input and which outputs a serial clock signal having a frequency corresponding to the bit rate of the HD-SDI video signal; a frequency divider 42 which divides the frequency of the serial clock signal by “20” (the number of bits N in one word of the HD-SDI video signal) to output a first word clock signal having a frequency corresponding to the word rate; a shift register 43 which delays the phase of the first word clock signal by one period of the serial clock signal at a time and gives this delay “19” times (corresponding to N-1 (N: the number of bits in one word of the HD-SDI video signal)) to output a group of word clock signals in a multiplicity of phases; an S/P conversion unit 44 to which the HD-SDI video signal, the serial clock signal and the first word clock signal are input, and which converts the HD-SDI video signal into parallel video signals based on the serial clock signal and outputs parallel video signals with the same period as that of the first word clock signal; a bit pattern detection unit 45 which determines whether or not all of predetermined consecutive bits in the parallel video signals are “1s” or “0s” with respect to the bits of the parallel video signals from a higher-order bit to a lower-order bit, and which outputs a first reference signal group and a second reference signal group representing the determination results; a bit phase detection unit 46 which detects phase information according to a timing reference bit sequence in the parallel video signals based on the first group of reference signals and the second group of reference signals; and a selector 47 to which the phase information and the group of word clock signals in the multiplicity of phases are input, and which selects and outputs the word clock signal having a phase coinciding with the phase information. Preferably, the word clock generator 40 further has a noise canceller 48 to which the phase information according to the timing reference signal in the parallel video signals is input, and which outputs the phase information if the phase information has the same value a certain number of times. The word clock generator 40 may further have a FIFO 49 to which the parallel video signals are input with the same period as that of the first word clock signal, and which outputs the parallel video signals with the same period as that of the word clock signal selected and output by the selector 47.

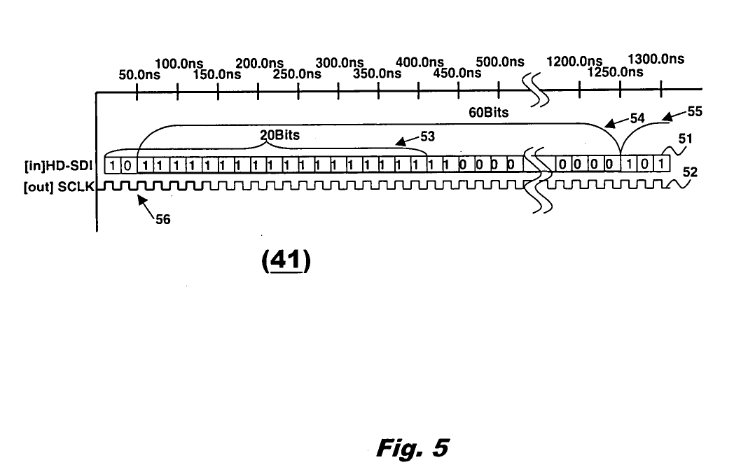

The operation of the word clock generator 40 will be described concretely with reference to FIGS. 5 to 9.

(PLL 41)

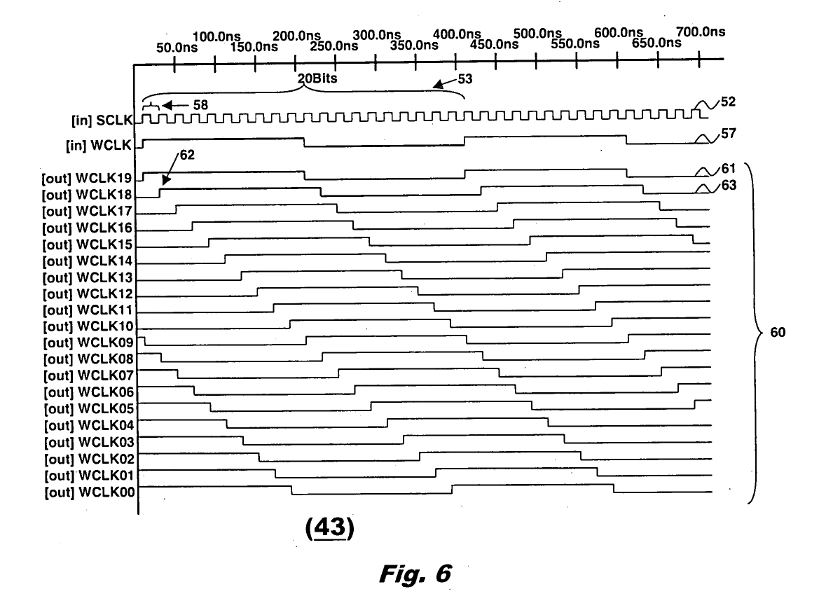

FIG. 5 shows HD-SDI video signal 51 input to the PLL 41 and serial clock signal 52 output from the PLL 41. The time indicated in FIG. 5 is changed from the actual time for ease of the following description. Also in FIGS. 6, 7B, 8A, 8B, 9, 10B, 11A, 11B, and 12, the indicated time is also different from the actual time. (The frequency of the actual serial clock signal is about 74 MHz and the period of the actual serial clock signal is about 13.5 ns).

In this embodiment, as shown in FIG. 5, the number of bits in one word of HD-SDI video signal 51 is twenty bits (arrow 53), and the timing reference bit sequence inherent in the HD-SDI video signal is a bit sequence formed of a leading group of consecutive twenty “1s” and a following group of consecutive forty “0s” (arrow 54). HD-SDI video signal 51 includes the timing reference bit sequence 54, a subsequent video signal 55 to be displayed by a display device such as a television, and a control information signal.

The PLL 41 is supplied with HD-SDI video signal 51 from each of video output devices, e.g., a VTR, a color bar generator and a camera, and outputs to the frequency divider 42 serial clock signal 52 having a frequency corresponding to the bit rate of the HD-SDI video signal (arrow 56).

(Frequency Divider 42)

The frequency divider 42 is supplied with serial clock signal 52 from the PLL 41 and divides the frequency of serial clock signal 52 by “20” (the number of bits N in one word of the HD-SDI video signal, indicated by arrow 53) to output the first word clock signal having a frequency corresponding to the word rate to the shift register 43, the S/P conversion unit 44 and the bit phase detection unit 46. Preferably, the frequency divider 42 outputs the first word clock signal to the noise canceller 48. The frequency divider 42 may output the first word clock signal to the FIFO 49.

(Shift Register 43)

FIG. 6 shows serial clock signal 52 and first word clock signal 57 input to the shift register 43, and a group of word clock signals 60 output from the shift register 43 in a multiplicity of phases. The shift register 43 is supplied with serial clock signal 52 from the PLL 41 and first word clock signal 57 from the frequency divider 42, delays the phase of first word clock signal 57 by one period of the serial clock signal at a time (arrow 58) and gives this delay “19” times (corresponding to N-1 (N: the number of bits in one word of the HD-SDI video signal)) to output. The shift register 43 thereby outputs a group of word clock signals 60 in a multiplicity of phases to the selector 47. The group of word clock signals 60 is formed of twenty word clock signals (WCLK19 to WCLK00). More specifically, the shift register 43 outputs first word clock signal 57 as word clock signal 61 (WCLK19); delays the phase of word clock signal 61 (WCLK19) by one period of the serial clock signal 52 (arrow 62) to output word clock signal 63 (WCLK18); . . . ; and delays the phase of word clock signal (WCLK01) by one period of the serial clock signal 52 to output the word clock signal (WCLK00). (S/P conversion unit 44)

The S/P conversion unit 44 is supplied with HD-SDI video signal from each of video output devices, e.g., a VTR, etc., serial clock signal 52 from the PLL 41, and first word clock signal 57 from the frequency divider 42, converts the HD-SDI video signal into parallel video signals having a width of “20” bits (corresponding to the number of bits N in one word of the HD-SDI video signal) by taking in one bit of the HD-SDI video signal with respect to every period of the serial clock signal, holds converted parallel video signals in four unit data groups (a predetermined number of unit data groups) with the same period as that of the first word clock signal so that the number of bits in a group of parallel video signals formed by combining the parallel video signals is equal to or larger than “60” (the total number of bits in the timing reference bit sequence in the HD-SDI video signal), and outputs the group of parallel video signals corresponding to eighty bits to the bit pattern detection unit 45 while shifting them by twenty bits for every period of the first word clock signal.

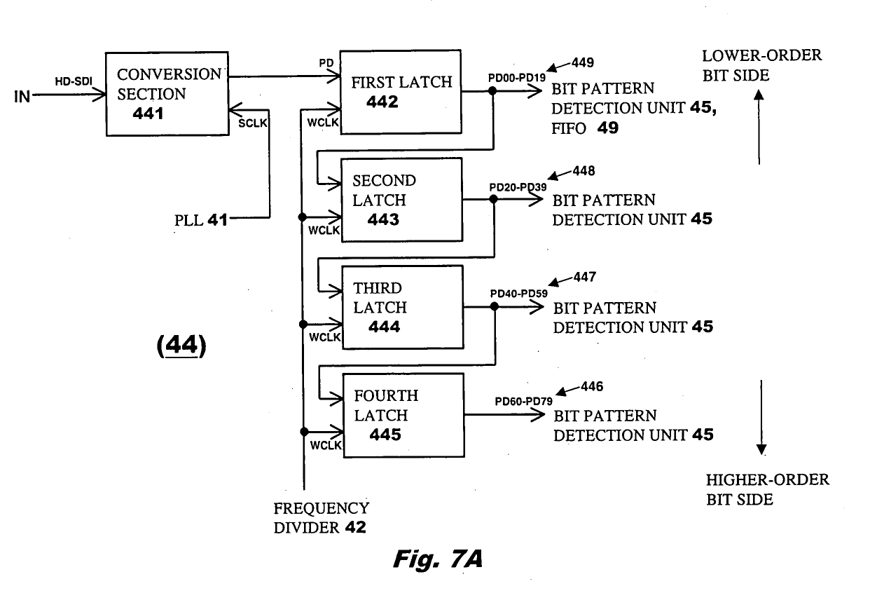

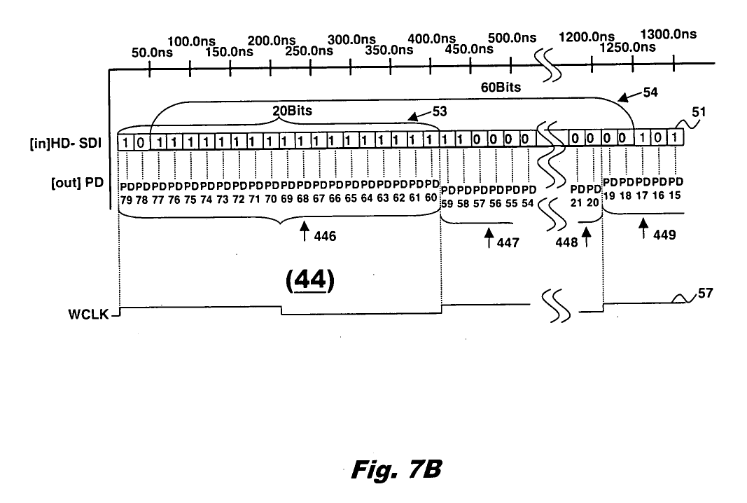

FIG. 7A is a block diagram showing details of the S/P conversion unit 44, and FIG. 7B shows the correspondence relationship between part of the HD-SDI video signal input to the S/P conversion unit 44 and part of parallel video signals output from the S/P conversion unit 44. In FIG. 7B, first word clock signal 57 shown in FIG. 6 is shown to facilitate understanding of details of the operation of the S/P conversion unit 44.

A conversion section 441 of the S/P conversion unit 44 is a shift register 441 having a 20-bit length. The shift register 441 is supplied with HD-SDI video signal from each video output device bit by bit, is supplied with serial clock signal 52 from the PLL 41, uses the input serial clock signal 52 as an operating clock, converts the HD-SDI video signal into parallel video signals having a width of “20” bits (the number of bits N in one word of the HD-SDI video signal) by setting the top bit of the HD-SDI video signal as a higher-order bit, and outputs the parallel video signals to a first latch 442.

As shown in FIGS. 7A and 7B, the conversion section 441 (shift register 441) of the S/P conversion unit 44, for example, is supplied with 20-bit HD-SDI video signal 53 (formed of two leading bits for the video signal and following eighteen bits for timing reference bit sequence 54) in the time period from 10.0 ns to 410.0 ns, shifts these bits in order to output the first parallel video signals (PD79 to PD60 indicated by arrow 446) to the first latch 442 at time 410.0 ns. Similarly, the conversion section 441 of the S/P conversion unit 44 outputs to the first latch 442 the second parallel video signals (PD59 to PD40 indicated by arrow 447) at time 810.0 ns; the third parallel video signals (PD39 to PD20 indicated by arrow 448) at time 1210.0 ns; and the fourth parallel video signals (PD19 to PD00 indicated by arrow 449) at time 1610.0 ns.

The first latch 442 of the S/P conversion unit 44 is supplied with the parallel video signals from the conversion section 441 and first word clock signal 57 from the frequency divider 42, holds the parallel video signals with the same period as that of the first word clock signal, and outputs the held parallel video signals to the bit pattern detection unit 45 and to a second latch 443. The second latch 443 of the S/P conversion unit 44 is supplied with the parallel video signals from the first latch 442 and first word clock signal 57 from the frequency divider 42, holds the parallel video signals with the same period as that of the first word clock signal, and outputs the held parallel video signals to the bit pattern detection unit 45 and to a third latch 444. The third latch 444 of the S/P conversion unit 44 is supplied with the parallel video signals from the second latch 443 and first word clock signal 57 from the frequency divider 42, holds the parallel video signal with the same period as that of the first word clock signal, and outputs the held parallel video signals to the bit pattern detection unit 45 and a fourth latch 445. The fourth latch 445 of the S/P conversion unit 44 is supplied with the parallel video signals from the third latch 444 and first word clock signal 57 from the frequency divider 42, holds the parallel video signals with the same period as that of the first word clock signal, and outputs the held parallel video signals to the bit pattern detection unit 45.

One of the first to fourth latches 442 to 445 (e.g., the first latch 442) may output to the FIFO 49 the parallel video signals with the same period as that of the first word clock signal.

For example, the first parallel video signals (PD79 to PD60) are output from the first latch 442 to the bit pattern detection unit 45 at time 410.0 ns; output from the second latch 443 to the bit pattern detection unit 45 at time 810.0 ns; output from the third latch 444 to the bit pattern detection unit 45 at time 1210.0 ns; and output from the fourth latch 445 to the bit pattern detection unit 45 at time 1610.0 ns. Similarly, the second parallel video signals (PD59 to PD40) are output from the first latch 442 at time 810.0 ns; output from the second latch 443 at time 1210.0 ns; and output from the third latch 444 at time 1610.0 ns. Similarly, the third parallel video signals (PD39 to PD20) are output from the first latch 442 at time 1210.0 ns, and output from the second latch 443 at time 1610.0 ns. Similarly, the fourth parallel video signals (PD19 to PD00) are output from the first latch 442 at time 1610.0 ns.

In other words, the S/P conversion unit 44 (first to fourth latches 442 to 445) completes at time 1610.0 ns outputting of the first to fourth parallel video signals (PD79 to PD00) as a group of parallel video signals to the bit pattern detection unit 45.

Each of the HD-SDI video signal and the SD-SDI video signal is NRZI (non-return to zero inverted) modulated for the purpose of improving the transmission performance. Therefore, the conversion section 441 of the S/P conversion unit 44 may execute the above-described operation by being supplied with the HD-SDI video signal demodulated in advance. Alternatively, the arrangement may be such that the S/P conversion unit 44 has a demodulation section (not shown) for demodulation of the converted parallel signals between the conversion section 441 (shift register 441) and the first latch 442, the conversion section 441 of the S/P conversion unit 44 executes the above-described operation by being supplied with the modulated HD-SDI video signal, and the parallel signals are demodulated by the demodulation section.

Scrambling (randomization) is performed, as well as NRZI modulation, on the HD-SDI video signal and the SD-SDI video signal for the purpose of improving the transmission performance. Therefore, the S/P conversion unit 44 may have a descrambling section (derandomization section) (not shown) for descrambling (derandomizing) the demodulated parallel signals between the demodulation section (not shown) and the first latch 442. In the conversion section 441 of the S/P conversion unit 44, the parallel signals may be demodulated by the demodulation section and the demodulated parallel signal may be descrambled (derandomized) by the descrambling section (derandomization section).

(Bit Pattern Detection Unit 45)

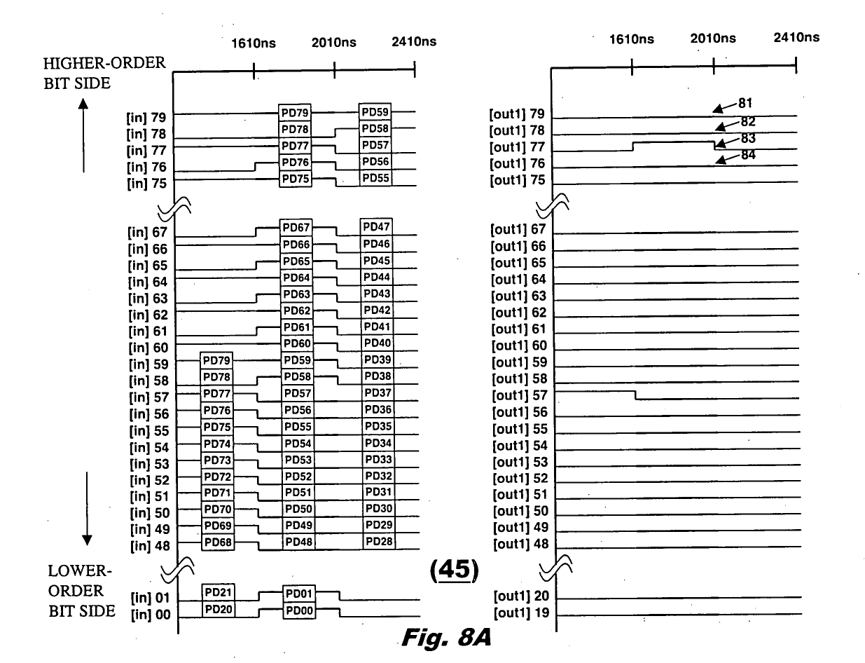

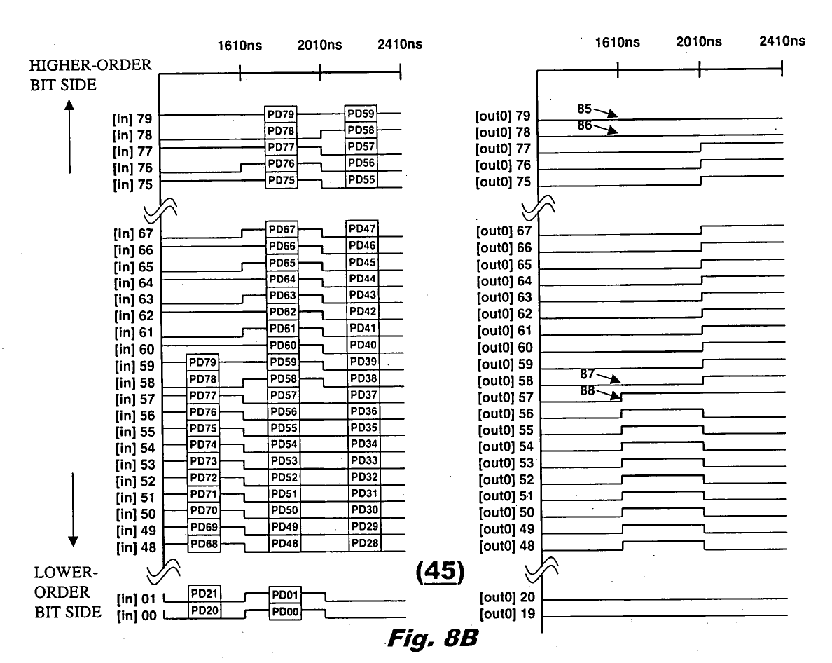

FIG. 8A is a diagram showing part of the group of parallel video signals input to the bit pattern detection unit 45 and part of the first group of reference signals output from the bit pattern detection unit 45. FIG. 8B is a diagram showing part of the group of parallel video signals input to the bit pattern detection unit 45 and part of the second group of reference signals output from the bit pattern detection unit 45. The bit pattern detection unit 45 is supplied with the group of parallel video signals (corresponding to eighty bits) from the S/P conversion unit 44, determines whether or not all of predetermined consecutive bits in the group of parallel video signals are “1s” or “0s” with respect to the bits of the parallel video signals from a higher-order bit to a lower-order bit, and outputs to the bit phase detection unit 46 the first group of reference signals and the second group of reference signals representing the determination results. More specifically, the bit pattern detection unit 45 is supplied with the first to fourth parallel video signals from the S/P conversion unit 44 (the first to fourth latches 442 to 445). The bit pattern detection unit 45 determines whether or not each of the consecutive twenty bits from a predetermined bit position in the first to fourth parallel video signals is “1” with respect to the bits of the first to fourth parallel video signals from a higher-order bit to a lower-order bit, and outputs the first group of reference signals (out1) representing the determination results. The bit pattern detection unit 45 further determines whether or not each of the consecutive twenty bits from the predetermined bit position in the first to fourth parallel video signals is “0” with respect to the bits of the first to fourth parallel video signals from the higher-order bit to the lower-order bit, and outputs the second group of reference signals (out0) representing the determination results.

For example, as shown in FIG. 8A, not all the leading twenty bits (PD79 to PD60) in the first to fourth parallel video signals (PD79 to PD00) are “1s” in the time period from 1610.0 ns to 2010.0 ns, and the bit pattern detection unit 45 accordingly outputs “0” representing negation as a first reference signal (out1: 79) (arrow 81);

not all the following twenty bits (PD78 to PD59) are “1s” and the bit pattern detection unit 45 accordingly outputs “0” representing negation as a first reference signal (out1: 78) (arrow 82);

all the further following twenty bits (PD77 to PD58) are “1s” (see FIG. 7B) and the bit pattern detection unit 45 accordingly outputs “1” representing affirmation as a first reference signal (out1: 77) (arrow 83); and

not all the further following twenty bits (PD76 to PD56) are “1s” and the bit pattern detection unit 45 accordingly outputs “0” representing negation as a first reference signal (out1: 76) (arrow 84). The bit pattern detection unit 45 outputs other first reference signals (out1: 75 to 19) in the same manner.

As shown in FIG. 8B, not all the leading twenty bits (PD79 to PD60) in the first to fourth parallel video signals (PD79 to PD00) are “0s” in the time period from 1610.0 ns to 2010.0 ns, and the bit pattern detection unit 45 accordingly outputs “0” representing negation as a second reference signal (out0: 79) (arrow 85);

not all the following twenty bits (PD78 to PD59) are “0s” and the bit pattern detection unit 45 accordingly outputs “0” representing negation as a second reference signal (out0: 78) (arrow 86); . . . ;

not all the following twenty bits (PD58 to PD39) are “0s” and the bit pattern detection unit 45 accordingly outputs “0” representing negation as a second reference signal (out0: 58) (arrow 87); and

all the further following twenty bits (PD57 to PD38) are “0s” and the bit pattern detection unit 45 accordingly outputs “1” representing affirmation as a second reference signal (out0: 57) (arrow 88). The bit pattern detection unit 45 outputs other second reference signals (out0: 56 to 19) in the same manner.

As described above, the bit pattern detection unit 45 is supplied with the group of parallel video signals, determines whether or not all of consecutive twenty bits in the group of parallel video signals are “1s” or “0s”, and outputs the first group of sixty-one reference signals (out1: 79 to 19) and the second group of sixty-one reference signals (out0: 79 to 19) representing the determination results.

(Bit Phase Detection Unit 46)

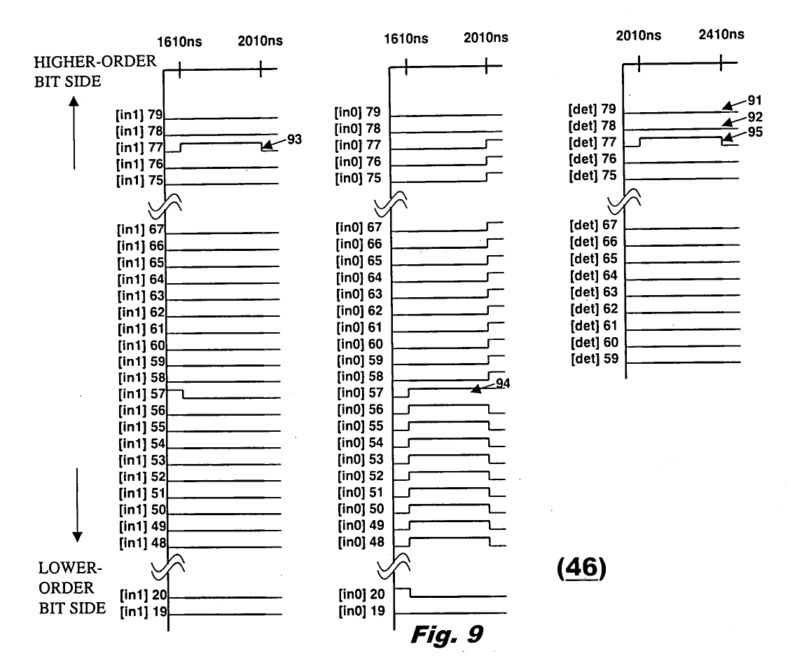

FIG. 9 shows part of first and second groups of reference signals input to the bit phase detection unit 46 and part of a group of determination signals generated by the bit phase detection unit 46. The bit phase detection unit 46 is supplied with the first and second groups of reference signals from the bit pattern detection unit 45, detects the phase information according to the timing reference bit sequence in the group of parallel video signals on the basis of the first and second groups of reference signals, and outputs the phase information to the selector 47. Preferably, the bit phase detection unit 46 outputs the phase information to the noise canceller 48.

More specifically, the bit phase detection unit 46 determines whether one first reference signal and two second reference signals at intervals of twenty bits in the first group of sixty-one reference signals (in1: 79 to 19) and the second group of sixty-one reference signals (in0: 79 to 19) represent the timing reference bit sequence in the group of parallel video signals (in which all the leading twenty bits are “1s” and all the other forty bits are “0s”) with respect to the bits of the first and second reference signals from the higher-order bit to the lower-order bit, and generates twenty-one determination signals (det: 79 to 59) representing the determination results.

For example, as shown in FIG. 9, not all of one first reference signal (in1: 79) corresponding to the most significant bit, one second reference signal (in0: 59) corresponding to the bit twenty bits lower than the most significant bit, and one second reference signal (in0: 39) corresponding to the bit twenty bits lower than the above-mentioned lower bit in the first group of sixty-one reference signals (in1: 79 to 19) and the second group of sixty-one reference signals (in0: 79 to 19) are “1s” at a time 2010.0 ns, these signals do not represent the timing reference bit sequence, and the bit phase detection unit 46 accordingly generates “0” representing negation as a determination signal (det: 79) (arrow 91);

not all of one first reference signal (in1: 78) corresponding to the bit one bit lower than the most significant bit, one second reference signal (in0: 58) corresponding to the bit twenty bits lower than the above-mentioned lower bit, and one second reference signal (in0: 38) corresponding to the bit twenty bits lower than the second lower bit in the first group of sixty-one reference signals (in1: 79 to 19) and the second group of sixty-one reference signals (in0: 79 to 19) are “1s” and the bit phase detection unit 46 accordingly generates “0” representing negation as a determination signal (det: 78) (arrow 92); and

all of one first reference signal (in1: 77 (arrow 93)) corresponding to the bit two bits lower than the most significant bit, one second reference signal (in0: 57 (arrow 94)) corresponding to the bit twenty bits lower than the above-mentioned lower bit, and one second reference signal (in0: 37) corresponding to the bit twenty bits lower than the second lower bit in the first group of sixty-one reference signals (in1: 79 to 19) and the second group of sixty-one reference signals (in0: 79 to 19) are “1s” and the bit phase detection unit 46 accordingly generates “1” representing affirmation as a determination signal (det: 77) (arrow 95). The bit phase detection unit 46 generates other determination signals (det: 76 to 59) in the same manner.

The bit phase detection unit 46 determines the number of the determination signal from the higher-order bit in the group of determination signals (det: 79 to 59) is “1” representing affirmation, and outputs the corresponding ordinal number as phase information to the selector 47.

(Selector 47)

The selector 47 is supplied with the phase information from the bit phase detection unit 46 and the group of word clock signals in a multiplicity of phases (WCLK19 to WCLK00) from the shift register 43, selects the word clock signal having the phase coinciding with the phase information, and outputs the selected word clock signal from the word clock generator 40. For example, the phase information (det: 77 shown in FIG. 9) is the third signal, and the selector 47 accordingly selects the third word clock signal (WCLK17 shown in FIG. 6) in order of increasing phase in comparison with the phase of the first word clock signal. The selector 47 may output the selected word clock signal to the FIFO 49.

The word clock generator 40 of the present invention can therefore output the word clock signal having the phase corresponding to the timing reference bit sequence inherent in the HD-SDI video signal. Consequently, it can output the word clock signal with stability. The bit pattern detection unit 45 can be constituted by AND circuits each of which forms one stage for one reference signal, and the bit phase detection circuit 46 can be constituted by AND circuits each of which forms one stage for one determination signal. Therefore, the word clock generator 40 of the present invention can operate at a high speed.

(Noise Canceller 48)

Preferably, the word clock generator 40 further has the noise canceller 48. The noise canceller 48 is supplied with the phase information according to the timing reference bit sequence in the group of parallel video signals from the bit pattern detection unit 46, and outputs the phase information to the selector 47 if the same value of the phase information occurs a certain number of times (e.g., three times). Therefore, the word clock generator 40 of the present invention can output the word clock signal in phase with the position at which the timing reference bit sequence starts even in a case where an abnormality occurs in the input signal (HD-SDI video signal) due to noise or the like.

(FIFO 49)

The word clock generator 40 may further have the FIFO 49. The FIFO 49 is supplied with the parallel video signals from the S/P conversion unit 44, the first word clock signal from the frequency divider 42 and the selected word clock signal from the selector 47. The FIFO 49 is supplied with the parallel video signals with the same period as that of the first word clock signal, and outputs the parallel video signals with the same period as that of the selected word clock signal.

The first word clock signal and the selected word clock signal have the same period and different phases (but there is a possibility of their phases coinciding with each other). Therefore, the parallel video signals output from the FIFO 49 can maintain the complete data in comparison with the parallel video signal input to the FIFO 49 and are output in phase with the selected word clock signal. Therefore, inputting/processing of the parallel video signal from the word clock generator 40 (FIFO 49) is free from problems relating to timing at the time of inputting of the parallel video signals (e.g., a problem that part of data is lost, and a problem that input data is identified as neither “1” nor “0” (a metastable state)), and the parallel video signals can be suitably processed.

### Second Embodiment

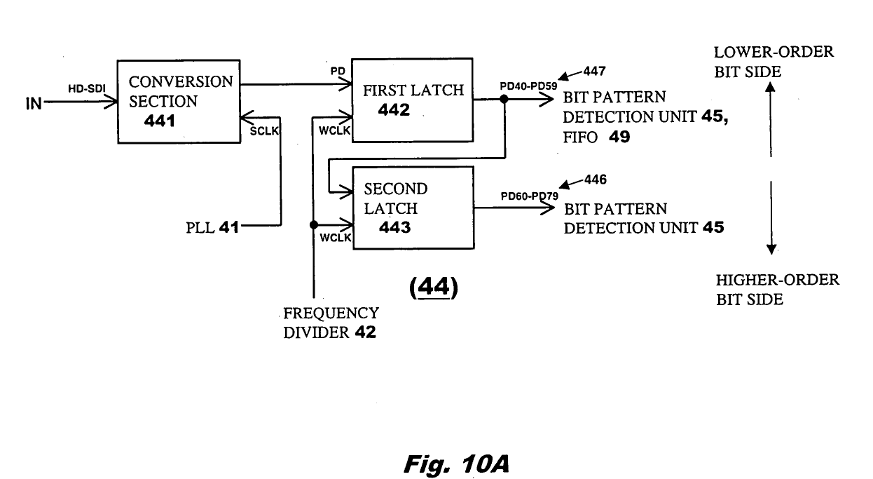

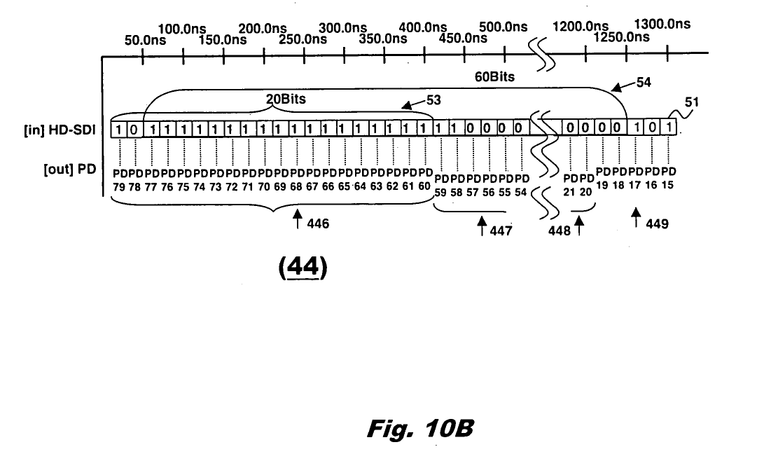

The S/P conversion unit 44 of the word clock generator 40 of the present invention can be modified to have a configuration such as shown in FIG. 10A in detail instead of the configuration shown in detail in FIG. 7A. Accordingly, the S/P conversion unit 44 of a second embodiment of the present invention can be simplified in comparison with that of the first embodiment. As shown in FIG. 10A, the S/P conversion unit 44 has two latches 442 and 443. The operation of the second embodiment of the present invention will be described only on different operation from that in the first embodiment.

(S/P Conversion Unit 44)

For example, the first parallel video signals (PD79 to PD60) are output from the first latch 442 to the bit pattern detection unit 45 at time 410.0 ns and output from the second latch 443 to the bit pattern detection unit 45 at time 810.0 ns. Similarly, the second parallel video signals (PD59 to PD40) are output from the first latch 442 at time 810.0 ns and output from the second latch 443 at time 1210.0 ns. Similarly, the third parallel video signals (PD39 to PD20) are output from the first latch 442 at time 1210.0 ns and output from the second latch 443 at time 1610.0 ns. Similarly, the fourth parallel video signals (PD19 to PD00) are output from the first latch 442 at time 1610.0 ns.

In other words, the output from the S/P conversion unit 44 (first and second latches 442 and 443) is updated with the same period as the first word clock signal, and the S/P conversion 44 outputs the first and second parallel video signals (PD79 to PD40) to the bit pattern detection unit 45 at time 810.0 ns, the second and third parallel video signals (PD59 to PD20) at time 1210.0 ns, the third and fourth parallel video signals (PD39 to PD00) to the bit pattern detection unit 45 at time 1610.0 ns.

(Bit Pattern Detection Unit 45)

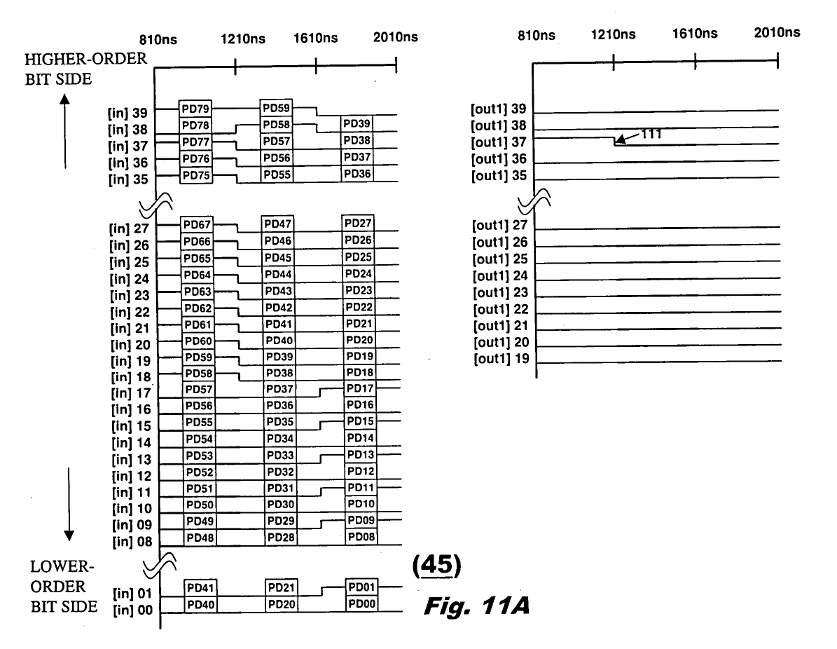

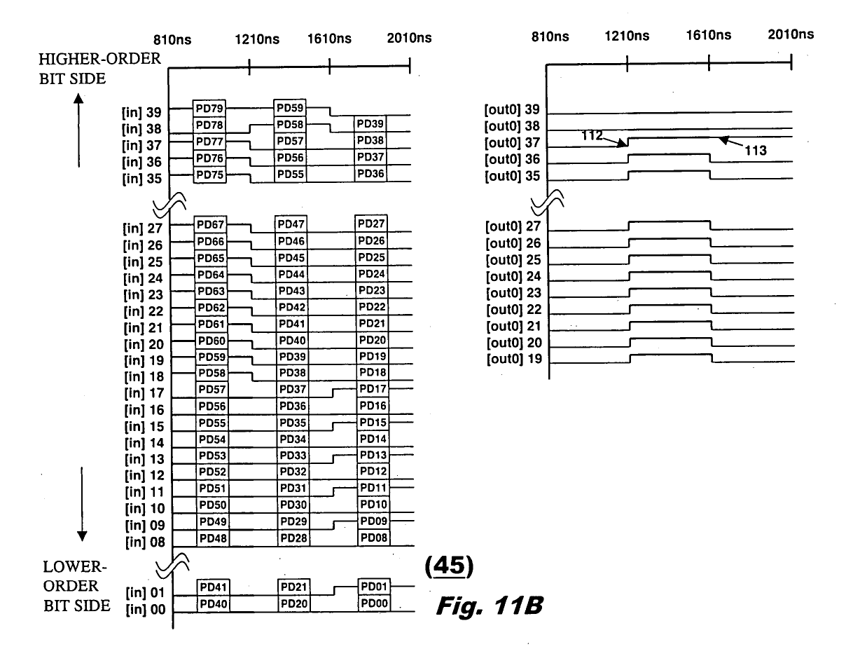

FIGS. 11A and 11B are diagrams showing the signals input to the bit pattern detection unit 45 and the signals output from the bit pattern detection unit 45, as are FIGS. 8A and 8B. The bit pattern detection unit 45 is supplied with the group of parallel video signals (corresponding to forty bits) from the S/P conversion unit 44, determines whether or not all of predetermined consecutive bits in the group of parallel video signals are “1s” or “0s” with respect to the bits of the parallel video signals from a higher-order bit to a lower-order bit, and outputs to the bit phase detection unit 46 the first group of reference signals and the second group of reference signals representing the determination results. More specifically, the bit pattern detection unit 45 is supplied with the first to fourth parallel video signals from the S/P conversion unit 44. The bit pattern detection unit 45 determines whether or not all the consecutive twenty bits in the group of parallel video signals are “1s” with respect to the bits of the group of parallel video signals from the higher-order bit to the lower-order bit, and outputs a first group of 21 reference signals (out1: 39 to 19) representing the determination results. The bit pattern detection unit 45 further determines whether or not all the consecutive twenty bits in the group of parallel video signals are “0s” with respect to the bits of the group of parallel video signals from the higher-order bit to the lower-order bit, and outputs a second group of 21 reference signals (out0: 39 to 19) representing the determination results.

For example, as shown in FIG. 11A, not all the leading twenty bits (PD79 to PD60) in the group of parallel video signals (PD79 to PD40) are “1s” in the time period from 810.0 ns to 1210.0 ns, and the bit pattern detection unit 45 accordingly outputs “0” representing negation as a first reference signal (out1: 39);

not all the following twenty bits (PD78 to PD59) are “1s” and the bit pattern detection unit 45 accordingly outputs “0” representing negation as a first reference signal (out1: 38); and

all the further following twenty bits (PD77 to PD58) are “1s” (see FIG. 10B) and the bit pattern detection unit 45 accordingly outputs “1” representing affirmation as a first reference signal (out1: 37) (arrow 111).

As shown in FIG. 11B, not all the leading twenty bits (PD59 to PD40) in the first to fourth groups of parallel video signals (PD59 to PD20) are “0s” in the time period from 1210.0 ns to 1610.0 ns, and the bit pattern detection unit 45 accordingly outputs “0” representing negation as a second reference signal (out0: 39);

not all the following twenty bits (PD58 to PD39) are “0s” and the bit pattern detection unit 45 accordingly outputs “0” representing negation as a second reference signal (out0: 38); and

all the further following twenty bits (PD57 to PD38) are “0s” and the bit pattern detection unit 45 accordingly outputs “1” representing affirmation as a second reference signal (out0: 37) (arrow 112).

Similarly, all the further following twenty bits (PD37 to PD18) are “0s” in the time period from time 1610.0 ns to 2010.0 ns and the bit pattern detection unit 45 accordingly outputs “1” representing affirmation as a second reference signal (out0: 37) (arrow 113).

(Bit Phase Detection Unit 46)

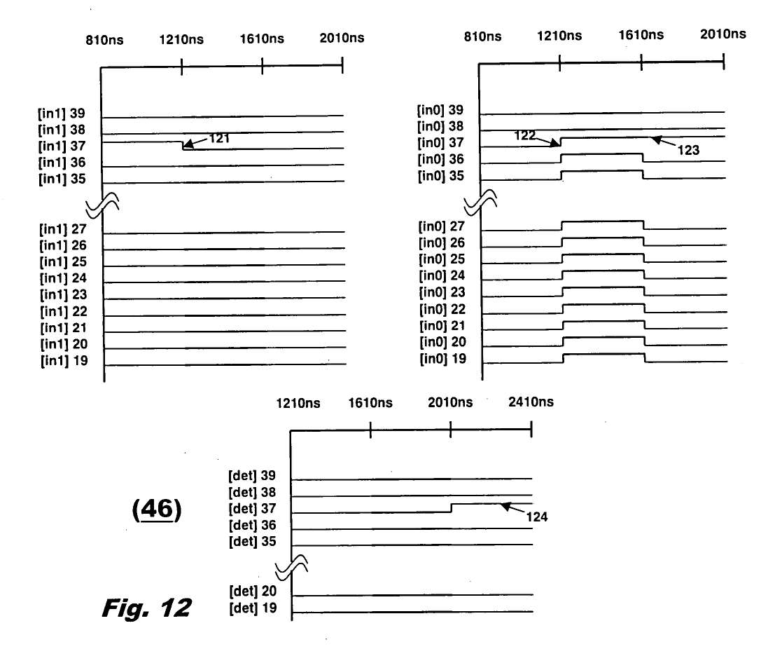

FIG. 12 shows the first and second groups of reference signals input to the bit phase detection unit 46 and phase information output from the bit phase detection unit 46, as does FIG. 9.

The bit phase detection unit 46 determines whether one first reference signal and two second reference signals over consecutive three periods of the first word clock signal in the first group of 21 reference signals (in1: 39 to 19) and the second group of 21 reference signals (in0: 39 to 19) represent the timing reference bit sequence in the parallel video signals (in which all the leading twenty bits are “1s” and all the other forty bits are “0s”) with respect to the predetermined bit positions in the first group of reference signals and the second group of reference signals and with respect to the bits of the first and second groups of reference signals from a higher-order bit to a lower-order bit, and generates twenty-one determination signals (det: 39 to 19) representing the determination results.

For example, as shown in FIG. 12, not all of one first reference signal (in1: 39) in the first period (time 1210.0 ns), one second reference signal (in0: 39) in the second period (time 1610.0 ns), and one second reference signal (in0: 39) in the third period (time 2010.0 ns) are “1s” with respect to the most significant bits of the first and second groups of reference signals in the first group of 21 reference signals (in1: 39 to 19) and the second group of 21 reference signals (in0: 39 to 19) in the time period from time 1210.0 ns to time 2010.0 ns (corresponding to consecutive three periods of the first word clock signal), these signals do not represent the timing reference bit sequence, and the bit phase detection unit 46 accordingly generates “0” representing negation as a determination signal (det: 39);

not all of one first reference signal (in1: 38) in the first period (time 1210.0 ns), one second reference signal (in0: 38) in the second period (time 1610.0 ns), and one second reference signal (in0: 38) in the third period (time 2010.0 ns) are “1s” with respect to the bits one bit lower than the most significant bits in the first and second groups of reference signals in the first group of 21 reference signals (in1: 39 to 19) and the second group of 21 reference signals (in0: 39 to 19), and the bit phase detection unit 46 accordingly generates “0” representing negation as a determination signal (det: 38); and

all of one first reference signal (in1: 37) in the first period (time 1210.0 ns) (arrow 121), one second reference signal (in0: 37) in the second period (time 1610.0 ns) (arrow 122), and one second reference signal (in0: 37) in the third period (time 2010.0 ns) (arrow 123) are “1s” with respect to the bits two bits lower than the most significant bits in the first and second groups of reference signals in the first group of 21 reference signals (in1: 39 to 19) and the second group of 21 reference signals (in0: 39 to 19), and the bit phase detection unit 46 accordingly generates “1” representing affirmation as a determination signal (det: 37) (arrow 124).

The bit phase detection unit 46 determines the number of the determination signal from the higher-order bit in the group of determination signals (det: 39 to 19) is “1” representing affirmation, and outputs the corresponding ordinal number (e.g., the third) as phase information to the selector 47.

Needless to say, the word clock generator 40 of the present invention is not limited to the examples described above with reference to the drawings, and various changes and modifications can be made in the described embodiments without departing from the gist of the invention. For example, in a case where an SD-SDI video signal is input instead of the HD-SDI video signal to the word clock generator 40 of the present invention, the number of bits N in one word is ten and a timing reference bit sequence (corresponding to thirty bits) inherent in the SD-SDI video signal is, for example, a bit sequence formed of a leading group of consecutive ten “1s” and a following group of consecutive twenty “0s”. In a case where a serial digital signal (including a serial digital audio signal and a serial digital video signal or the like) is input instead of the HD-SDI video signal to the word clock generator 40 of the present invention, each of the above-described examples described with reference to the drawings can be easily modified on the basis of the number of bits N in one word and a predetermined timing reference bit sequence inherent in the serial digital signal. Also, the number of latches of the S/P conversion unit 44 can be changed to 1, for example.

What is claimed is:

1. A word clock generator comprising:
means for outputting a serial clock signal having a frequency corresponding to the bit rate of a serial digital signal which is externally supplied to said means and in which the number of bits in one word set as one data unit is “N”;
means for outputting a first word clock signal having a frequency corresponding to the word rate by dividing the frequency of the serial clock signal by N;
means for outputting a group of N word clock signals in a multiplicity of phases by delaying the phase of the first word clock signal by one period of the serial clock signal at a time and by giving said delay (N-1) times;
means for converting the serial digital signal into parallel signals on the basis of the serial clock signal, said conversion means being supplied with the serial digital signal, the serial clock signal and the first word clock signal;
means for determining whether or not a predetermined timing reference bit sequence exists in the parallel signals, and for detecting phase information according to the timing reference bit sequence if the timing reference bit sequence exists; and
means for selecting the word clock signal having a phase coinciding with the phase information from the group of word clock signals in a multiplicity of phases, and for outputting the selected word clock signal, said selection means being supplied with the phase information and the group of word clock signals in a multiplicity of phases.

2. A word clock generator comprising:
means for outputting a serial clock signal having a frequency corresponding to the bit rate of a serial digital signal which is externally supplied to said means (and in which the number of bits in one word set as one data unit is “N”);
means for outputting a first word clock signal having a frequency corresponding to the word rate by dividing the frequency of the serial clock signal by N;
means for outputting a group of N word clock signals in a multiplicity of phases by delaying the phase of the first word clock signal by one period of the serial clock signal at a time and by giving said delay (N-1) times;
means for converting the serial digital signal into parallel signals on the basis of the serial clock signal, said conversion means being supplied with the serial digital signal, the serial clock signal and the first word clock signal;
means for determining whether or not all of predetermined consecutive bits in the parallel signals are “1s” or “0s” with respect to the bits of the parallel signals from a higher-order bit to a lower-order bit, and for outputting a first group of reference signals and a second group of reference signals representing the results of said determination;
means for detecting phase information according to a timing reference bit sequence in the parallel signals on the basis of the first group of reference signals and the second group of reference signals, said detection means being supplied with the first group of reference signals, the second group of reference signals and the first word clock signal; and
means for selecting the word clock signal having a phase coinciding with the phase information from the group of word clock signals in a multiplicity of phases, and for outputting the selected word clock signal, said selection means being supplied with the phase information and the group of word clock signals in a multiplicity of phases.

3. A word clock generator comprising:
means for outputting a serial clock signal having a frequency corresponding to the bit rate of a serial digital signal which is externally supplied to said means (and in which the number of bits in one word set as one data unit is “20”);
means for outputting a first word clock signal having a frequency corresponding to the word rate by dividing the frequency of the serial clock signal by 20;
means for outputting a group of twenty word clock signals in a multiplicity of phases by delaying the phase of the first word clock signal by one period of the serial clock signal at a time and by giving said delay 19 times;
means for converting the serial digital signal into parallel signals having a width of twenty bits on the basis of the serial clock signal, said conversion means being supplied with the serial digital signal and the serial clock signal;
means for outputting a group of parallel signals corresponding to eighty bits on the basis of the parallel signals;
means for determining whether or not each of consecutive twenty bits from a predetermined bit position in the group of parallel signals is “1” or “0” with respect to the bits of the parallel signals from a higher-order bit to a lower-order bit, and for outputting a first group of reference signals and a second group of reference signals representing the results of said determination;
means for determining whether one first reference signal and two second reference signals at intervals of twenty bits represent a timing reference bit sequence in the parallel signals (in which each of leading twenty bits is “1” and each of the other forty bits is “0”), and for detecting phase information according to the timing reference bit sequence on the basis of the one first reference signal and the two second reference signals representing the timing reference bit sequence, said determination and detection means being supplied with the first group of reference signals, the second group of reference signals and the first word clock signal; and
means for selecting the word clock signal having a phase coinciding with the phase information from the group of word clock signals in a multiplicity of phases, and for outputting the selected word clock signal, said selection means being supplied with the phase information and the group of word clock signals in a multiplicity of phases.

4. A word clock generator comprising:
means for outputting a serial clock signal having a frequency corresponding to the bit rate of a serial digital signal which is externally supplied to said means (and in which the number of bits in one word set as one data unit is “20”);
means for outputting a first word clock signal having a frequency corresponding to the word rate by dividing the frequency of the serial clock signal by 20;
means for outputting a group of twenty word clock signals in a multiplicity of phases by delaying the phase of the first word clock signal by one period of the serial clock signal at a time and by giving said delay 19 times;
means for converting the serial digital signal into parallel signals having a width of twenty bits on the basis of the serial clock signal, said conversion means being supplied with the serial digital signal and the serial clock signal;
means for outputting a group of parallel signals corresponding to forty bits on the basis of the parallel signals;
means for determining whether or not each of consecutive twenty bits from a predetermined bit position in the group of parallel signals is “1” or “0” with respect to the bits of the parallel signals from a higher-order bit to a lower-order bit, and for outputting a first group of reference signals and a second group of reference signals representing the results of said determination;
means for determining whether one first reference signal and two second reference signals over consecutive three periods of the first word clock signal represent a timing reference bit sequence in the parallel signals (in which each of the leading twenty bits is “1” and each of the other forty bits is “0”) with respect to the predetermined bit positions in the first group of reference signals and the second group of reference signals, and for detecting phase information according to the timing reference bit sequence on the basis of the one first reference signal and the two second reference signals representing the timing reference bit sequence, said determination and detection means being supplied with the first group of reference signals, the second group of reference signals and the first word clock signal; and
means for selecting the word clock signal having a phase coinciding with the phase information from the group of word clock signals in a multiplicity of phases, and outputting the selected word clock signal, said selection means being supplied with the phase information and the group of word clock signals in a multiplicity of phases.

5. The word clock generator according to claim 1, wherein said means for outputting the groups of N word clock signals in a multiplicity of phases comprises a shift register.

6. The word clock generator according to claim 2, wherein said means for outputting the groups of N word clock signals in a multiplicity of phases comprises a shift register.

7. The word clock generator according to claim 3, wherein said means for outputting the groups of N word clock signals in a multiplicity of phases comprises a shift register.

8. The word clock generator according to claim 4, wherein said means for outputting the groups of N word clock signals in a multiplicity of phases comprises a shift register.

9. The word clock generator according to claim 1, wherein said means for converting the serial digital signal into the parallel signals demodulates and derandomizes the converted parallel signal and outputs the demodulated and derandomized parallel signals.

10. The word clock generator according to claim 2, wherein said means for converting the serial digital signal into the parallel signals demodulates and derandomizes the converted parallel signal and outputs the demodulated and derandomized parallel signals.

11. The word clock generator according to claim 3, wherein said means for converting the serial digital signal into the parallel signals demodulates and derandomizes the converted parallel signal and outputs the demodulated and derandomized parallel signals.

12. The word clock generator according to claim 4, wherein said means for converting the serial digital signal into the parallel signals demodulates and derandomizes the converted parallel signal and outputs the demodulated and derandomized parallel signals.

13. The word clock generator according to claim 5, wherein said means for converting the serial digital signal into the parallel signals demodulates and derandomizes the converted parallel signal and outputs the demodulated and derandomized parallel signals.

14. The word clock generator according to claim 6, wherein said means for converting the serial digital signal into the parallel signals demodulates and derandomizes the converted parallel signal and outputs the demodulated and derandomized parallel signals.

15. The word clock generator according to claim 7, wherein said means for converting the serial digital signal into the parallel signals demodulates and derandomizes the converted parallel signal and outputs the demodulated and derandomized parallel signals.

16. The word clock generator according to claim 8, wherein said means for converting the serial digital signal into the parallel signals demodulates and derandomizes the converted parallel signal and outputs the demodulated and derandomized parallel signals.

17. The word clock generator according to claim 1, wherein the serial digital signal comprises an HD-SDI (high definition-serial digital interface signal).

18. The word clock generator according to claim 2, wherein the serial digital signal comprises an HD-SDI (high definition-serial digital interface signal).

19. The word clock generator according to claim 3, wherein the serial digital signal comprises an HD-SDI (high definition-serial digital interface signal).

20. The word clock generator according to claim 4, wherein the serial digital signal comprises an HD-SDI (high definition-serial digital interface signal).

21. The word clock generator according to claim 5, wherein the serial digital signal comprises an HD-SDI (high definition-serial digital interface signal).

22. The word clock generator according to claim 6, wherein the serial digital signal comprises an HD-SDI (high definition-serial digital interface signal).

23. The word clock generator according to claim 7, wherein the serial digital signal comprises an HD-SDI (high definition-serial digital interface signal).

24. The word clock generator according to claim 8, wherein the serial digital signal comprises an HD-SDI (high definition-serial digital interface signal).

25. The word clock generator according to claim 9, wherein the serial digital signal comprises an HD-SDI (high definition-serial digital interface signal).

26. The word clock generator according to claim 10, wherein the serial digital signal comprises an HD-SDI (high definition-serial digital interface signal).

27. The word clock generator according to claim 11, wherein the serial digital signal comprises an HD-SDI (high definition-serial digital interface signal).

28. The word clock generator according to claim 12, wherein the serial digital signal comprises an HD-SDI (high definition-serial digital interface signal).

29. The word clock generator according to claim 13, wherein the serial digital signal comprises an HD-SDI (high definition-serial digital interface signal).

30. The word clock generator according to claim 14, wherein the serial digital signal comprises an HD-SDI (high definition-serial digital interface signal).

31. The word clock generator according to claim 15, wherein the serial digital signal comprises an HD-SDI (high definition-serial digital interface signal).

32. The word clock generator according to claim 16, wherein the serial digital signal comprises an HD-SDI (high definition-serial digital interface signal).
